(19) United States
(12) Patent Application Publication
(10) Pub. No.: US 2026/0024459 A1
(43) Pub. Date: Jan. 22, 2026

(54) DIFFERENTIATING TECHNOLOGY TO DIFFERENTIATE BETWEEN CAUSAL MISTAKES MADE BY A USER IN A TEST IN AN ONLINE LEARNING PLATFORM

(71) Applicant: 2hr Learning, Inc., Austin, TX (US)

(72) Inventors: Bogdan Tenea, Austin, TX (US); Simon Said, Malta (MA); Samy Aboel-Nil, Austin, TX (US)

(73) Assignee: 2hr Learning, Inc., Austin, TX (US)

(21) Appl. No.: 19/273,056

(22) Filed: Jul. 17, 2025

Related U.S. Application Data
(60) Provisional application No. 63/672,375, filed on Jul. 17, 2024.

(51) Int. Cl. G09B 7/08

(52) U.S. Cl. CPC G09B 7/08

(57) ABSTRACT

The carelessness check system analyzes the nature of mistakes while attempting a primary test and subsequently providing a follow-up test. The method includes receiving the responses of the user by the response tracker while attempting a primary test. The evaluator then evaluates the incorrect responses of the user. Utilizing this information, the test preparation module prepares a follow-up test. The user then attempts the follow-up test and answers the questions. The careless detection module identifies the nature of response of the user given in the follow-up test such that answering two questions correctly in the follow-up test indicates carelessness and answering the first follow-up question indicates a conceptual misunderstanding.

### CROSS-REFERENCE TO RELATED APPLICATION(S)

This application claims the benefit under 35 U.S.C. § 119 (c) and 37 C.F.R. § 1.78 of U.S. Provisional Application No. 63/672,375, which is incorporated by reference in its entirety.

### FIELD OF THE INVENTION

The present invention relates in general to the field of electronics, and more specifically to a system of differentiating between mistakes made due to carelessness or conceptual misunderstanding of the user, giving a test in an online learning platform. The user is provided with a follow-up test to check whether the mistake is made due to carelessness or is there any conceptual misunderstanding.

### BACKGROUND OF THE INVENTION

Educational testing involves the assessment of the student. Educational testing is a measuring tool to determine the degree of knowledge, skills, and abilities a student has acquired. The educational tests often identify the student's ability to perform certain tasks and demonstrate mastery of a skill or knowledge on a particular concept. The educational tests can be presented to the user in the form of MCQs, quizzes, fill-in-the-blanks, true/false, and so on. The fate of the students within the education system is defined by how well they perform in the exam and have knowledge of a particular concept.

The educational testing involves administering a comprehensive test covering various concepts. Historically if a student answers the questions incorrectly, the typical response includes revisiting the entire concepts that the student got incorrect. However, revisiting the entire concept does not provide an efficient reason behind the error resulting in significant inefficiencies and thus not identifying the reason behind the students' incorrect response. The approach requires a significant amount of time and resources to visit each concept the student got incorrect which can lead to disengagement due to unnecessary repetition of the study material the user has already learned.

The traditional educational testing methods offer a one-size-fits-all approach to test the knowledge of the students. Notably, the educational testing methods require students to visit all the concepts regardless of knowing the reason for the mistake which is very time-consuming. The one-size-fits-all approach suggests students revisit all the concepts the student got incorrect rather than focusing on the reason behind their mistakes.

### SUMMARY

In at least one embodiment, a method differentiates between careless mistakes and conceptual misunderstandings made by a user during an initial online learning platform. The method includes executing code using one or more processors of a computer system to cause the computer system to perform operations. The operations include collecting details of a primary test given by the user in the online learning platform and separating incorrect answers provided by the user. The method includes analyzing primary test results, wherein the analysis includes listing concepts answered incorrectly by identifying each concept answered incorrectly during the primary test. The method includes providing a follow-up test to the user immediately after the primary test, wherein the follow-up test includes up to two questions corresponding to each concept answered incorrectly during the primary test. The method includes evaluating the user's responses to the follow-up test to determine whether each initial incorrect response results from a careless mistake or a conceptual misunderstanding. In cases where the response is determined as a conceptual misunderstanding, the method includes providing the user with educational content to master the concept. The method includes displaying evaluated result carelessness check results that map each tested concept to either a careless mistake or a conceptual misunderstanding based on the evaluation of the follow-up questions.

In at least one embodiment, a system differentiates between careless mistakes and conceptual misunderstandings made by a user during a primary test in an online learning platform by providing a follow-up test. The system includes one or more processors of a computer system and a memory, coupled to the one or more processors, storing code that, when executed, causes the computer system to perform operations. The operations include collecting details of the primary test provided by the user in a testing engine, given by the user in the online learning platform using a data collector, and separating incorrect answers provided by the user. The operations include analyzing primary test results using an analyzer, wherein the analysis includes listing concepts answered incorrectly by identifying each concept answered incorrectly during the primary test. The operations include providing a follow-up test to the user immediately after the primary test using a re-testing engine, wherein the follow-up test includes up to two questions corresponding to each concept answered incorrectly during the primary test. The operations include evaluating the user's responses to the follow-up test using a response tracking module to determine whether each initial incorrect response results from a careless mistake or a conceptual misunderstanding. In cases where the response is determined as a conceptual misunderstanding, the operations include providing the user with educational content to master the concept. The operations include displaying evaluated result carelessness check results that map each tested concept to either a careless mistake or a conceptual misunderstanding based on the evaluation of the follow-up questions.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary carelessness check system to differentiate between a careless mistake and conceptual misunderstanding in the user's primary assessment responses using an online learning platform.

FIG. 2 depicts an exemplary carelessness check system process based on the follow-up test provided to the user using an online learning platform.

FIG. 3 depicts a flowchart disclosing the steps involved in generating the test.

FIG. 4 depicts an exemplary use of a carelessness check system other than the online learning platform.

FIG. 5 depicts an exemplary network environment in which the system of FIG. 1 and the process of FIG. 2 may be practiced.

FIG. 6 depicts an exemplary computer system.

### DETAILED DESCRIPTION

A carelessness check system in an online learning platform to differentiate between careless mistakes and conceptual misunderstandings by a user while giving a primary test in an online learning platform and subsequently providing a follow-up test. The user attempts the primary test in an online learning platform. The careless detection system is coupled to the online learning platform to analyze the nature of the responses a user attempts. To accomplish this, a response tracker receives the responses, a user gives while attempting the primary test. The response tracker tracks and stores the responses given by the user. The collected responses are then analyzed by an evaluator which analyzes the incorrect responses of the user. The evaluator maps the responses from the exam data to identify the incorrect responses given by the user. As the responses are analyzed the test preparation module prepares a follow-up-test for the user to attempt once the whole test is completed.

The follow-up test is displayed on the online learning platform. The response tracker receives and stores the responses of the follow-up test. The careless detection module is integrated within the evaluator of the careless detection system which analyzes the collected responses to classify the nature of the mistakes. The careless detection module employs an algorithm that evaluates the responses to classify the nature of the mistakes a user makes while attempting the follow-up test. The careless detection module classifies the initial mistake as careless when the user answers two follow-up questions correctly while attempting the follow-up test. The careless detection module classifies the initial mistake as a conceptual misunderstanding when the user answers the first question incorrectly while attempting the follow-up test.

The careless detection module identifies the nature of the mistake and provides efficient targeted feedback to the user which focuses on re-learning the concepts and standards that the user has conceptual misunderstanding about. Consequently, this leads to a better outcome by providing a customized learning path, enhancing the learning outcomes, and reducing the time spent on test preparation and review.

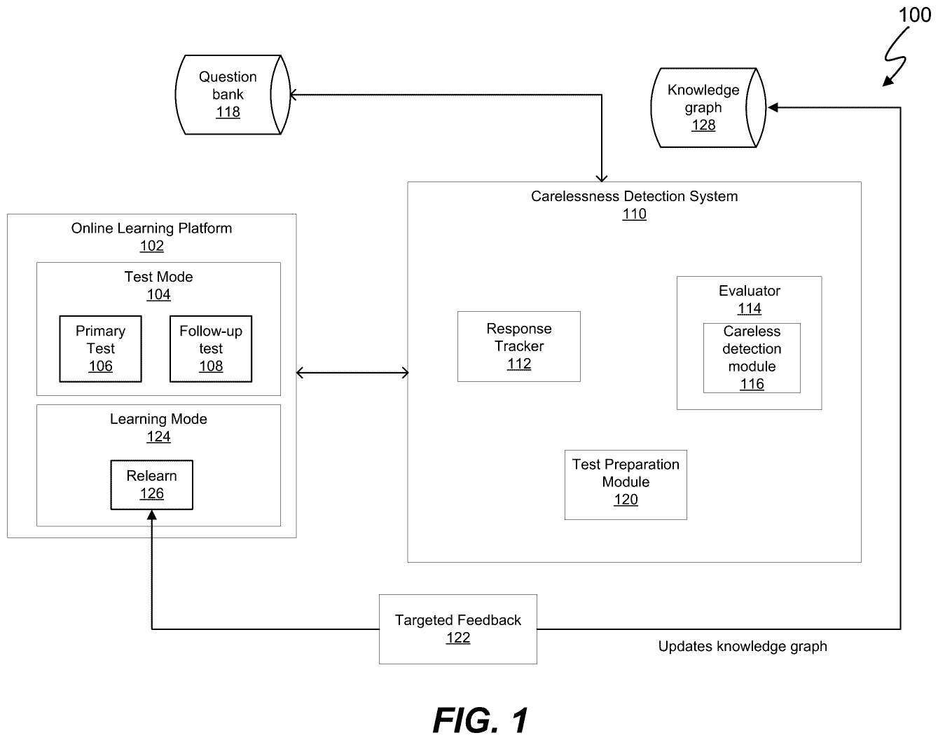

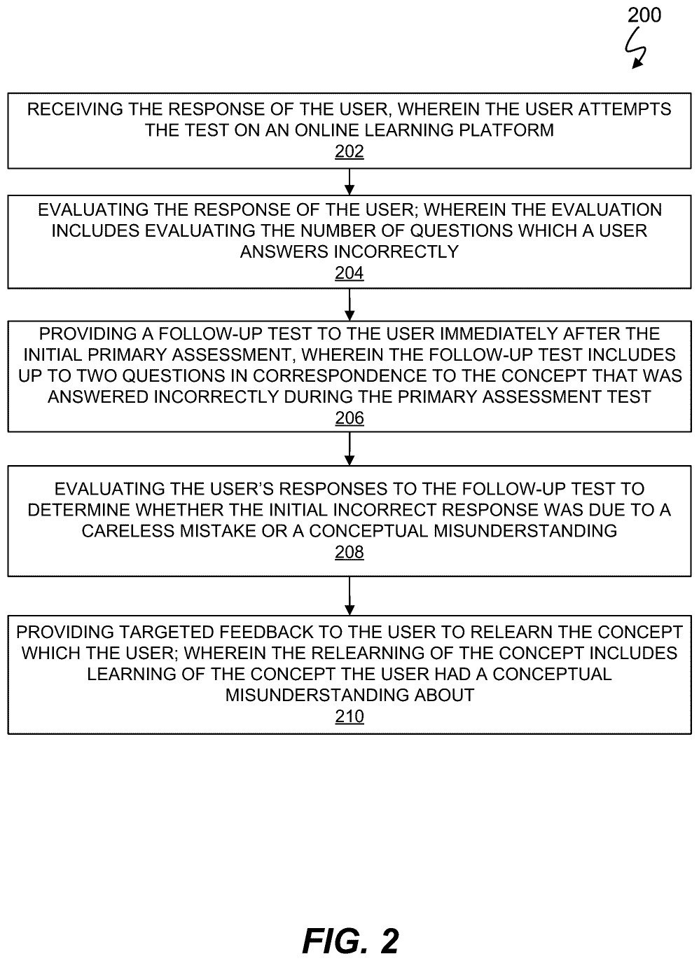

FIG. 1 depicts an exemplary carelessness check system 100 to differentiate between careless mistakes and conceptual misunderstanding in the user's primary assessment responses. FIG. 2 depicts an exemplary carelessness check system process 200 utilized by carelessness check system 100.

Referring to FIGS. 1 and 2, in operation 202, a test mode 104 provides a primary test 106 to the user, and response tracker 112 integrated within a carelessness detection system 110 receives the responses of the user attempted in the primary test 106.

The user interacts with the online learning platform 102 and is presented with a primary test 106 in a test mode 104 feature of the online learning platform 102. The test mode 104 on the online learning platform 102 presents tests related to a particular course the user is studying. The test mode 104 presents the primary test 106 to the user once the user finishes learning the entire course. The primary test 106 includes questions related to various concepts of a particular course, the user is studying. In one of the embodiments, the primary test 106 contains 40-100 questions. The primary test 106 is displayed on the online learning platform 102 and the user attempts the test as soon as the user completes studying an entire course. For instance, when the user finishes studying the whole course of AP biology, the user will attempt the primary test 106 presented on an online learning platform 102 related to AP biology. The primary test 106 includes questions from each standard of AP biology.

In one of the embodiments, the primary test 106 includes fill-in-the-blanks, MCQ (Multiple Choice Questions), and True or False. The online learning platform 102 is coupled with a carelessness detection system 110. The carelessness detection system 110 includes different components that provide a customized test and analyze the nature of mistakes the user makes when he/she is attempting the test. The carelessness detection system 110 checks if the user answers the questions incorrectly due to carelessness or genuine misunderstanding of the concepts.

The response tracker 112 within the carelessness detection system 110 receives the responses of the user when he/she is attempting the primary test 106. The response tracker 112 tracks and stores the received responses which are attempted by the user in the primary test 106.

Referring to FIGS. 1 and 2, in operation 204, evaluating the received responses to identify the incorrect responses, wherein the evaluation includes mapping each question against a specific standard to identify incorrect responses.

The evaluator 114 within the carelessness detection system 110 collects responses from the response tracker 112 and evaluates the responses attempted by the user in the primary test 106. The evaluator 114 evaluates the responses given by the user and maps each response of the user to the response stored within the question bank 118.

Question bank 118 includes pre-stored questions related to a particular standard along with their correct responses. The question bank 118 includes questions mapped to a main standard which consists of questions from each concept of a different course. The evaluator 114 maps the responses given by the user to the correct answers present in question bank 118. Evaluator 114 finds the best possible match for the attempted response. In one of the embodiments, NLP can be used to understand the user's response. The evaluator 114 evaluates the number of incorrect responses once the primary test 106 is completed.

Referring to FIGS. 1 and 2, in operation 206, providing a follow-up test 108 to the user immediately after the initial primary assessment, wherein the follow-up test 108 includes up to two questions in correspondence to the concept that was answered incorrectly during the primary assessment test.

The test preparation module 120 within the carelessness detection system 110 receives input from the evaluator 114 about the number of incorrect responses attempted by the user in the primary test 106. For instance, the user is studying AP biology, and on completing the course, the user wants to test his/her knowledge about the concepts related to AP biology to prepare for the exam. The user attempts a primary test 106 which includes questions related to the standards of AP biology. The test consists of 100 questions of AP biology. The user attempts the primary test 106 and the response tracker 112 receives the responses. The evaluator 114 upon evaluating identifies that the user got 20 incorrect questions.

The test preparation module 120 prepares a follow-up test 108 based on the input received from the evaluator 114. The follow-up test 108 includes 2 questions per incorrectly answered concept. The test preparation module 120 looks for questions in question bank 118 similar to the questions that the user got incorrect. The questions in the follow-up test 108 are of the same difficulty level and similar concept based on the questions the user got incorrect while attempting the primary test 106. The test preparation module 120 then prepares a test based on the inputs and displays on the test mode 104 of the online learning platform 102. In one of the embodiments, the user can access the follow-up test 108 immediately when the user gets a question incorrect or can access the follow-up test 108 once the user has completed the primary test 106. The follow-up test 108 adapts based on the student's initial response.

The follow-up test 108 evaluates if the user is not able to answer the question because of carelessness or genuine misunderstanding of the concept. The number of follow-up questions is contingent upon the user's initial test response.

For instance, if a user gets 20 questions incorrect, the test preparation module 120 will prepare the follow-up test 108 related to these questions that the user answers incorrectly. The follow-up test 108 includes 2 questions per each incorrect response given by the user such that the follow-up test 108 consists of 40 questions.

Referring to FIGS. 1 and 2, in operation 208, evaluating the user's responses to the follow-up test 108 to determine whether the initial incorrect response was due to a careless mistake or a conceptual misunderstanding, wherein in case the response is determined as a conceptual misunderstanding, the user is provided with targeted feedback 122.

The user attempts the follow-up test 108 and the response tracker 112 receives the responses attempted by the user while attempting the follow-up test 108. The evaluator 114 will receive the responses from the response tracker 112 and evaluate the response the user attempts in the follow-up test 108.

The careless detection module 116 within the evaluator 114 of the careless detection system 110 analyzes the responses given by the user. The careless detection module 116 employs an algorithm to identify if the incorrect response is due to a careless mistake or a conceptual misunderstanding. The careless detection module 116 maps each tested concept to either a “careless mistake” or “conceptual misunderstanding”. The careless detection module 116 classifies the mistake to be careless if the user answers the two follow-up questions correctly. The careless detection module 116 indicates a conceptual misunderstanding if the user answers the first follow-up question incorrectly. The conceptual misunderstanding indicates knowledge gaps.

For instance, if the user answers incorrectly the questions related to photosynthesis on the AP biology primary test 106, the test preparation module 120 will prepare a follow-up test 108 based on the questions related to photosynthesis. The questions will cover the same concept of photosynthesis with similar difficulty levels. If the user answers both questions correctly, then the careless detection module 116 analyzes the response given by the user due to a careless mistake in the follow-up test 108 including questions related to photosynthesis. If the user answers the first follow-up question incorrectly, then the careless detection module analyzes that the user has a conceptual misunderstanding about the concept related to photosynthesis.

Below is the pseudocode of the algorithm employed by the careless detection system 116 to evaluate the incorrect response and classify the nature of the mistake.

```
function administerCarelessnessCheck(testResults):
  Initialize carelessnessCheckResults as an empty dictionary
  For each incorrectConcept in testResults.incorrectConcepts:
    Set correctResponses to 0
    For i from 1 to 2:
      questionResult = askQuestion(incorrectConcept)
      If questionResult is “correct”:
        Increment correctResponses
        If correctResponses equals 2:
          Set carelessnessCheckResults[incorrectConcept] to
“careless mistake”
          Break
      Else:
        Set carelessnessCheckResults[incorrectConcept] to “conceptual
misunderstanding”
        Break
    If correctResponses equals 1:
      Set carelessnessCheckResults[incorrectConcept] to “conceptual
misunderstanding”
  Return carelessnessCheckResults
```

The pseudocode explains the process used by the careless detection system 110 to identify the nature of the mistake attempted by the user in the follow-up test 108. The careless detection module 116 first administers a carelessness check on the response of the follow-up test 108. The careless detection module 116 first keeps an empty dictionary used to store the data values of the responses. The careless detection module 116 assumes the correct responses to be zero initially. The follow-up test 108 asks questions related to the incorrect concept. If the increment of correct responses is equivalent to 2, the careless detection module 116 will detect the mistake due to carelessness. If the correct response is equivalent to 1 or 0, the careless detection module 116 will analyze the user has conceptual misunderstanding of the concept. The carelessness check results are then displayed to the user.

Referring to FIGS. 1 and 2, in operation 210, providing targeted feedback 122 to the user to relearn 126 the concept which the user; wherein the relearning of the concept includes the learning of the concepts the user had a conceptual misunderstanding about.

The careless detection module 116 identifies the nature of the mistake and provides targeted feedback 122 to the user based on the response and nature of the mistake. In one of the embodiments, the targeted feedback 122 includes a notification or pop-up displayed on the online learning platform 102. This pop-up reminds the user to relearn 126 the concept in the learning mode 124 of the online learning platform 102. The targeted feedback 122 includes the standards the user got wrong and should focus on relearning the particular concept of that standard. The targeted feedback 122 employs the user to relearn 126 the concepts from the sources presented in learning mode 124 of the online learning platform 102.

For instance, if a user lacks understanding of the concept related to cell structure and function, the targeted feedback 122 will be provided to relearn 126 the concepts related to cell structure and function. The content will be presented to the user in the form of questions related to cell structure and function which have higher weightage according to exam standpoint.

The targeted feedback 122 also updates the knowledge graph 128 in real-time. The knowledge graph 128 includes the mastery of the user for various concepts. As the user completes the course the user may attain mastery of the particular course. The knowledge graph 128 updates based on the response of the user and areas are marked where the user lacks knowledge of the concept. The knowledge graph 128 displays the areas the user needs to focus on.

The careless detection system 110 effectively distinguishes between different types of errors thus saving a significant amount of time and ensuring that the user only revisits the concepts, he/she misunderstands. For instance, if a user is taking a primary test 106 which covers the whole course of 100 individual concepts. The primary test 106 is composed of 100 questions, each question covers one concept. Evaluator 114 evaluates that 20 questions on the primary test 106 are answered incorrectly by the user. The following assumptions are made as the user attempts the test. The student takes 1 minute to answer each question. The careless detection module 116 identifies the nature of the mistake and considers that each student requires 15 minutes to learn a concept he/she has a conceptual misunderstanding about. The carelessness check system 100 employs 280 minutes to take tests and relearn 126 the concept.

The initial test takes about 100 minutes to answer with 1 minute required for each question while attempting the primary test and 100 questions require 100 minutes to answer. The user got 20 questions incorrect. The follow-up test prepared by the test preparation module will consist of 40 questions and it is assumed that the follow-up-test 108 requires 30 minutes to answer each question. The user takes 10 minutes to answer the 10 concepts and the user has a conceptual misunderstanding about assuming the first question answered by the user is incorrect. The user takes 20 minutes to answer the questions presented in the follow-up test and takes 1 minute to answer each concept. Each concept includes 2 questions. Based on the responses the targeted feedback 122 will provided to the user in the form of a notification to relearn 126 and focus on concepts that the user truly doesn't know. Assuming, that the user takes 15 minutes to relearn 126 each concept and the time required to relearn 126 concepts for 10 questions which the user did not know will be 150 minutes. The total time taken to retest and relearn 126 the concept includes 100 minutes for attempting the primary test 106 and 30 minutes to attempt the follow-up test 108, 150 minutes for relearning which is about 280 minutes and thus saving time and making the students more aware about the mistakes.

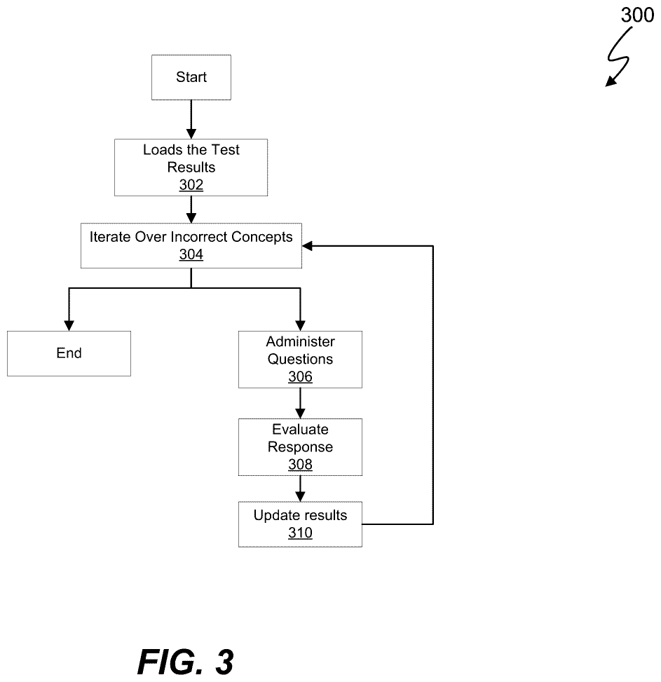

FIG. 3 depicts a flow chart representing a test generation system 300. The process starts with the user attempting the primary test 106. The test results are then tracked by the response tracker 112 which loads the test results 302. The evaluator 114 then iterates over incorrect concepts 304. The follow-up test 108 administers question 306 based on the incorrect response. The careless detection module 116 then evaluates response 308 and updates results 310 using targeted feedback 122 to the user presented to iterate over incorrect response 304.

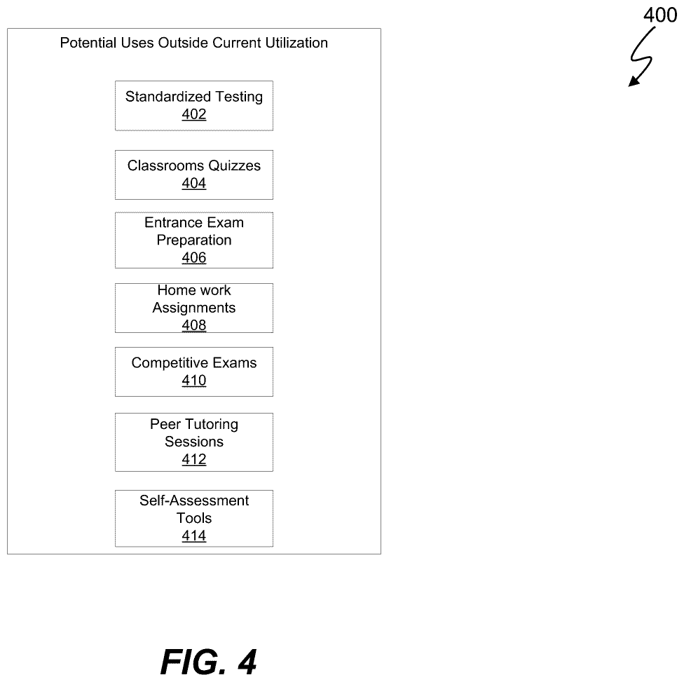

FIG. 4 depicts the potential use of a carelessness check system other than incorporation in online learning platform 102. The carelessness check system 100 can adapted for standardized testing 402 which can be used to determine the root cause of the student's mistake and provide tailored educational interventions more effectively.

The carelessness check system 100 can be adapted in classroom quizzes 404 where teachers can use this system to identify the nature of mistakes of the student and the teachers can provide an effective customized test tailored according to individual students, thus making the learning process more focused and providing an efficient feedback.

The carelessness check system 100 can be adapted for entrance exam preparation 406. The coaching centers may utilize this system to identify areas where students are making careless mistakes and areas where they genuinely lack understanding. The coaching centers can optimize the coaching provided and focus on more conceptual clarity or test-taking strategies.

The carelessness check system 100 can be adapted for homework assignment 408. The carelessness check system 100 can help the students analyze the errors while working on an assignment independently and real-time feedback can be provided by the teachers.

The carelessness check system 100 can be adapted for the preparation of competitive exams 410. The carelessness check system 100 can be utilized to understand the nature of the mistake and thus help students refine their study strategies and focus areas. These strategies help in improving the overall performance of the student.

The carelessness check system 100 can be adapted for peer tutoring sessions 412 which helps the tutors to understand the mistakes of the students. This ensures that tutoring sessions are efficient and focus on concepts that the student has a conceptual misunderstanding about rather than spending time on concepts the student already understands but slipped up on due to carelessness.

The carelessness check system 100 can be adapted for self-assessment tools 414. The carelessness check system can benefit the students in understanding the nature of their mistakes by providing immediate feedback on the nature of their mistakes allowing students to adjust their study habits and strategies accordingly without any external help.

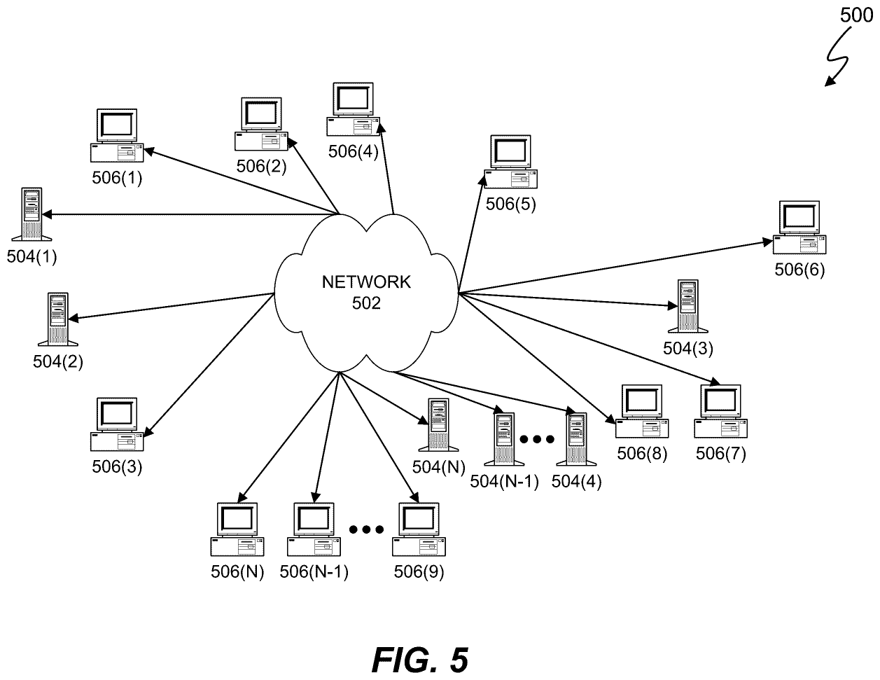

FIG. 5 is a block diagram illustrating a network environment in which a background carelessness check system 100 and process 200 based on the follow-up test 108 provided to the user using an online learning platform 102 may be practiced. Network 502 (e.g. a private wide area network (WAN) or the Internet) includes several networked server computer systems 504(1)-(N) that are accessible by client computer systems 506(1)-(N), where N is the number of server computer systems connected to the network. Communication between client computer systems 506(1)-(N) and server computer systems 504(1)-(N) typically occurs over a network, such as a public switched telephone network over asynchronous digital subscriber line (ADSL) telephone lines or high-bandwidth trunks, for example, communications channels providing TI or OC3 service. Client computer systems 506(1)-(N) typically access server computer systems 504(1)-(N) through a service provider, such as an internet service provider (“ISP”) by executing application-specific software, commonly referred to as a browser, on one of client computer systems 506(1)-(N).

Client computer systems 506(1)-(N) and server computer systems 504(1)-(N) are specialized computers programmed to improve conventional computer systems to implement and utilize the carelessness check system 100 based on the follow-up test 108 provided to the user using an online learning platform 102. The type of computer system that can be specially programmed to implement and utilize the carelessness check system 100 based on the follow-up test 108 provided to the user using an online learning platform 102 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the carelessness check system 100 based on the follow-up test 108 provided to the user using an online learning platform 102 can be implemented using code stored in a tangible, non-transient computer-readable medium and executed by one or more processors. In at least one embodiment, the background carelessness check system 100 based on the follow-up test 108 provided to the user using an online learning platform 102 can be implemented completely in hardware using, for example, logic circuits and other circuits including field programmable gate arrays.

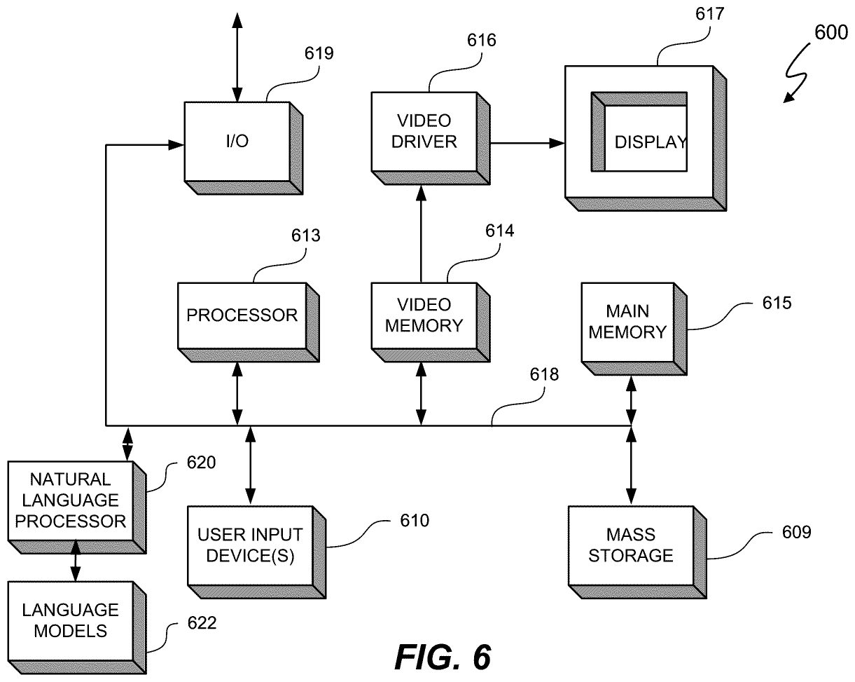

Embodiments of the background carelessness check system 100 based on the follow-up test 108 provided to the user using an online learning platform 102 can be implemented on a computer system such as a special-purpose, special-programmed computer 600 illustrated in FIG. 6. Input user device(s) 610, such as a keyboard and/or mouse, are coupled to a bi-directional system bus 618. The input user device(s) 610 are for introducing user input to the computer system and communicating that user input to processor 613. The computer system of FIG. 6 generally also includes a non-transitory video memory 614, non-transitory main memory 615, and non-transitory mass storage 609, all coupled to bi-directional system bus 618 along with input user device(s) 610 and processor 613. The mass storage 609 may include fixed and removable media, such as a hard drive, one or more CDs or DVDs, solid state memory including flash memory, and other available mass storage technology. Bus 618 may contain, for example, 32 of 64 address lines for addressing video memory 614 or main memory 615. The system bus 618 also includes, for example, an n-bit data bus for transferring DATA between and among the components, such as CPU 609, main memory 615, video memory 614, and mass storage 609, where “n” is, for example, 32 or 64. Alternatively, multiplex data/address lines may be used instead of separate data and address lines.

I/O device(s) 619 may provide connections to peripheral devices, such as a printer, and may also provide a direct connection to a remote server computer system via a telephone link or to the Internet via an ISP. I/O device(s) 619 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 609, into main memory 615 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 615 consists of dynamic random access memory (DRAM). Video memory 614 is a dual-ported video random access memory. One port of the video memory 614 is coupled to the video amplifier 616. The video amplifier 616 is used to drive the display 617. Video amplifier 616 is well-known in the art and may be implemented by any suitable means. This circuitry converts pixel DATA stored in video memory 614 to a raster signal suitable for use by display 617. Display 617 is a type of monitor suitable for displaying graphic images.

The computer system described above is for purposes of example only. The carelessness check system 100 based on the follow-up test 108 provided to the user using an online learning platform 102 may be implemented in any type of computer system programming or processing environment. It is contemplated that the carelessness check system 100 based on the follow-up test 108 provided to the user using an online learning platform 102 might be run on a stand-alone computer system, such as the one described above. The carelessness check system 100 based on the follow-up test 108 provided to the user using an online learning platform 102 might also be run from a server computer systems system that can be accessed by a plurality of client computer systems interconnected over an intranet network. Finally, the carelessness check system 100 based on the follow-up test 108 provided to the user using an online learning platform 102 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method of differentiating between careless mistakes and conceptual misunderstandings made by a user during an initial online learning platform, the method comprises:
executing code using one or more processors of a computer system to cause the computer system to perform operations comprising:
collecting details of the primary test given by the user in the online learning platform and separating the incorrect answers provided by the user;
analyzing the primary test results, wherein the analysis of the primary test results includes listing the concepts that are answered incorrectly by identifying the concept that was answered incorrectly during the primary test;
providing the follow-up test to the user immediately after the primary test, wherein the follow-up test includes up to two questions in correspondence to the concept that was answered incorrectly during the primary test;
evaluating the user's responses to the follow-up test to determine whether the initial incorrect response was due to a careless mistake or a conceptual misunderstanding, wherein in case the response is determined as a conceptual misunderstanding, the user is provided with educational content to master the concept;
displaying the evaluated result carelessness check results that map each tested concept to either a careless mistake or conceptual misunderstanding based on the evaluation of the follow-up questions.

2. The method of claim 1 wherein the primary test includes questions belonging to different concepts.

3. The method of claim 1 wherein the primary test responses are stored in a database containing the user's initial test results, specifically listing the concepts that were answered incorrectly.

4. The method of claim 1 wherein the concept that was answered incorrectly during the primary test is mapped either as a careless mistake or a conceptual misunderstanding based on the evaluation of the follow-up test response.

5. The method of claim 1 further comprises:
a question bank linked to the standard of the user from where the questions are selected for the follow-up test which are in correspondence to the concept that was answered incorrectly during the primary test.

6. The method of claim 1 wherein the evaluation of follow-up test response further comprises:
classifying the initial incorrect response as a careless mistake if the user answers two follow-up questions correctly;
classifying the initial incorrect response as a conceptual misunderstanding if the user answers the first follow-up question incorrectly.

7. The method of claim 1 wherein the questions of the follow-up test are generated in the same pattern and difficulty level as compared to the concept answered incorrectly during the primary test.

8. The method of claim 1 wherein the questions in the primary test and the follow-up test include Fill-in-the-Blanks, MCQ (Multiple Choice Questions), and True or False.

9. The method of claim 1 wherein a feedback is provided to the user indicating the standard of the user, the incorrect answers made by the user during the primary test, and the output status of the incorrect responses after giving the follow-up tests.

10. A system to differentiate between careless mistakes and conceptual misunderstandings made by the user during a primary test in an online learning platform by providing a follow-up test comprises:
one or more processors of a computer system; and
a memory, coupled to the one or more processors, storing code that when executed causes the computer system to perform operations comprising:
collecting details of the primary test provided by the user in a testing engine, which is given by the user in the online learning platform using a data collector and separating the incorrect answers provided by the user;
analyzing the primary test results using an analyzer, wherein the analysis of the primary test results includes listing the concepts that are answered incorrectly by identifying the concept that was answered incorrectly during the primary test;
providing the follow-up test to the user immediately after the primary test using a re-testing engine, wherein the follow-up test includes up to two questions in correspondence to the concept that was answered incorrectly during the primary test;
evaluating the user's responses to the follow-up test to determine whether the initial incorrect response was due to a careless mistake or a conceptual misunderstanding using a response tracking module, wherein in case the response is determined as a conceptual misunderstanding, the user is provided with educational content to master the concept;
displaying the evaluated result carelessness check results that map each tested concept to either a careless mistake or conceptual misunderstanding based on the evaluation of the follow-up questions.

11. The system of claim 9 wherein the user's responses to the follow-up test to determine whether the initial incorrect response was due to a careless mistake or a conceptual misunderstanding is displayed to the user on a user interface integrated within the online learning platform.

12. The system of claim 9 further comprises:
a question bank linked to the standard of the user from where the re-testing engine selects the relevant question in correspondence to the concept that was answered incorrectly during the primary test.

13. The system of claim 9 wherein the primary test responses are stored in a test response database containing the user's initial test results, specifically listing the concepts that were answered incorrectly.

14. The method of claim 1 further comprises a classification module configured to:
classify the initial incorrect response as a careless mistake if the user answers two follow-up questions correctly;
classify the initial incorrect response as a conceptual misunderstanding if the user answers the first follow-up question incorrectly.

15. The system of claim 9 wherein a feedback is provided to the user using a feedback module indicating the standard of the user, the incorrect answers made by the user during the primary test, and the output status of the incorrect responses after giving the follow-up tests.

16. The system of claim 9 wherein the recommendations are provided for further achieving mastery in the concept if the initial incorrect response is determined to be a conceptual misunderstanding.
